(19) United States
(12) Patent Application Publication
(10) Pub. No.: US 2008/0034090 A1
(43) Pub. Date: Feb. 7, 2008

(54) Tender-Bid Method and Architecture For Intelligent Network Resource Deployment

(75) Inventors: Bruce Schofield, Tyngsboro, MA (US); Franco Travostino, Arlington, MA (US); Inder Monga, Acton, MA (US)

Correspondence Address: McGUINNESS & MANARAS LLP, 125 NAGOG PARK, ACTON, MA, 01720, US

(73) Assignee: Nortel Networks Limited

(21) Appl. No.: 11/469,395

(22) Filed: Aug. 31, 2006

Related U.S. Application Data
(60) Provisional application No. 60/721,757, filed on Sep. 29, 2005.

(51) Int. Cl. G06F 15/173

(52) U.S. Cl. 709/225

(57) ABSTRACT

A method and architecture of the present invention uses market-driven resource selection and mission deployment techniques to increase mission performance by optimizing network resource utilization. A mission controller forwards a service tender to a plurality of coupled network service entities to inquire about the costs associated with one or more services in the service set of the mission. Each network service entity may return a bid to the mission controller including a projected cost for the performance of the one or more services by the associated network service entity. The mission controller evaluates the bids received from the network service entities to select a network service entity for mission execution. Network resources selection is thus optimized using real-time network service entity cost information, thereby increasing the chance for mission success. Network service entities may increase revenue by identifying opportunities to participate in missions suited to their capabilities.

### RELATED APPLICATIONS

This application claims priority under 37 C.F.R. § 1.119(e) to provisional patent application 60/721,757 filed Sep. 29, 2005 and incorporated herein by reference.

### FIELD OF THE INVENTION

This invention relates generally to resource management and more particularly to a method and apparatus for generating and using time-value curves for resource management.

### BACKGROUND OF THE INVENTION

The effectiveness of any mission is heavily reliant upon the ability of an underlying infrastructure to respond to the dynamic requirements of the mission. Typically missions are layered upon an existing resource infrastructure such that the mission becomes merely a set of tasks that is supported by the infrastructure. Layering a mission upon an existing infrastructure typically mis-utilizes key resources and increases the difficulty in detecting performance degradation or partial failures that adversely affect the mission. Allocating specific resources to a mission is technically challenging and error prone. It would be desirable to identify a mission architecture which would overcome the problems of the prior art.

### SUMMARY OF THE INVENTION

A method and architecture of the present invention uses market-driven resource selection and mission deployment techniques to increase mission performance by optimizing network resource utilization. In one embodiment, a mission is represented as a set of services. A mission controller forwards a service tender to a plurality of coupled network service entities to obtain best matches between service requirements and network resources with one or more services in the service set of the mission. Each network service entity may return a bid to the mission controller, the bid includes a set of available resources and their availability, taking into account the mission's relative priority The mission controller evaluates the bids received from the network service entities to select a network service entity for mission execution.

Such an arrangement allows the mission controller to intelligently allocate mission services to network resources because the cost information reflects the real-time cost to each particular network entity at the time the mission service set is requested. As a result, network resources usage is optimized and the chance for mission success is increased.

In addition, the arrangement allows network service entities to increase their revenue by allowing them to identify opportunities to participate in missions which are best suited to their capabilities.

These and other aspects of the invention will be described in further detail in the attached figures.

### BRIEF DESCRIPTION OF THE FIGURES

FIG. 1 is a block diagram of a mission architecture in which the present invention may be implemented;

FIG. 2 is a diagram illustrating several objects that may be included in a general service offering data structure associated with an Intentional Network Service (INS) entity of the present invention;

FIG. 3 is a flow diagram illustrating exemplary steps that may be performed during a tender-bid process by a mission controller of the present invention;

FIGS. 4A and 4B illustrate exemplary objects that may be included in tender and bid data structures for exchanging communication between a mission controller and INS entity of the present invention; and

FIG. 5 is a flow diagram illustrating several exemplary steps that may be performed by a network manager when responding to a tender issued by the mission controller using the process of FIG. 3;

### DETAILED DESCRIPTION

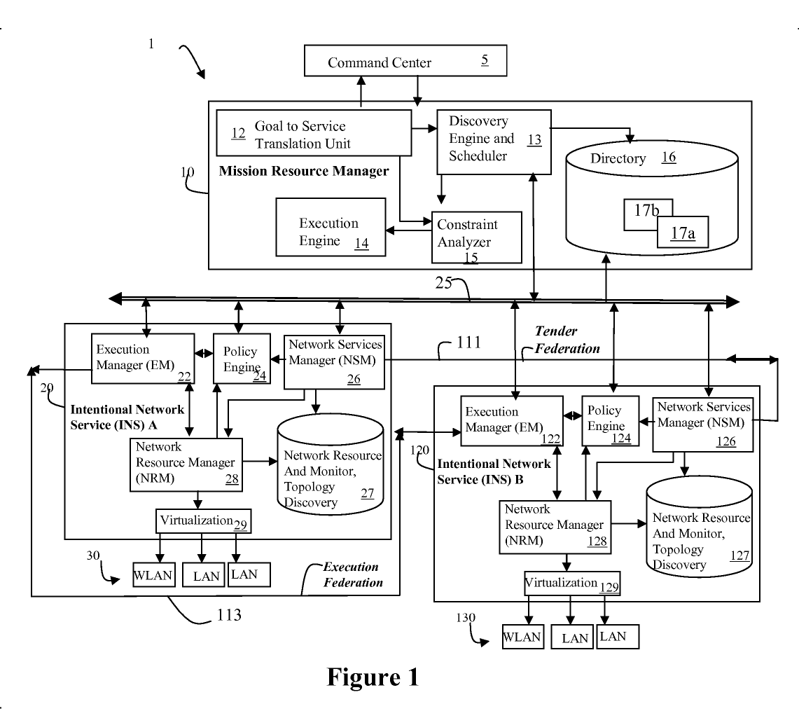

FIG. 1 illustrates a mission architecture 1 in which the present invention may advantageously be used to optimize mission resource utilization. In one embodiment the mission architecture 1 is an adaptive network that uses Workflow Locked Loops (WLL) for mission resource selection and access management. An architecture that uses WLL is described in patent application serial number ______ (attorney docket number 120-506 “Workflow Locked Loops to Enable Adaptive Networks” filed ______ by Travostino et al., and incorporated herein by reference, although the present invention is not limited to use with this architecture.

The embodiment of FIG. 1 includes a Mission Resource Manager (MRM) 10 and an Intentional Network Service (INS) entity 12. For the purposes of this application, each Intentional Network Service (INS) entity 12 is a software controlled network capable of executing a variety of services and applications. The software controlled network includes a controlling entity comprised of an execution manager 22, a policy engine 24, a network services manager 26, a network resource manager 28, and a network resource monitor and topology discovery repository 27. The INS entity may include any number or type of controllable network resource.

The MRM 10 essentially orchestrates the use of mission resources by identifying mission tasks and allocating INS resources to the mission tasks. According to one aspect of the invention, the allocation of network resources to mission tasks is performed intelligently using a tender-bid process which allows multiple Intentional Network Service (INS) entities such as INS A 20 and INS B 120 to ‘bid’ on the ability to provide the services for each mission. As will be described in greater detail below, the MRM tenders mission service requests to the INS entities. The INS entities analyze the service requests and forward bids to the MRM, with the bids including a ‘cost’ to the INS entity to support the mission service requests. The MRM selects the INS with the best match of resources to service requirements resulting from a multi-dimensional analysis.

FIG. 1 illustrates several exemplary components that may be included in an MRM which supports the tender-bid process of the present invention. These components include a Goal to Service Translation Unit (GSTU) 12, a Discovery Engine and Scheduler (DES) 13, a Constraint Analyzer (CA) 15, an Execution Engine (EE) 14 and a Directory 16.

The GSTU 12 may be a semantic tool which maps a high level goal definition, such as a natural language definition, into real-language mission goals into policy statements. One exemplary method for performing Goal to Service translation is described in Ser. No. ______ (Attorney Docket No.: 120-505), entitled Mission Goal Statement to Policy Statement Translation, by Travostino et al., filed ______ incorporated herein by reference. The policy statements are presented to the DES 13 in the form of a service template. The service template essentially includes a list of services, resources and applications that are used for mission support.

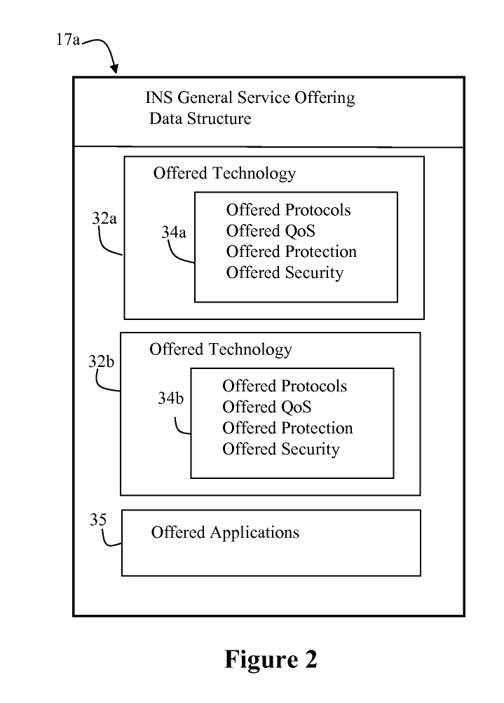

The DES 13 uses the service template provided by the GSTU 12 as the basis for a search of the directory 16. The directory 16 stores, for each INS entity, a General Service Offering Data Structure (GSO DS), such as 17a and 17b. The GSO data structure essentially identifies the services and applications that are available to the MRM for mission support. FIG. 2 illustrates several exemplary objects that may be included in a GSO data structure 17a. The GSO of FIG. 2 is shown organized into offered technology objects, each including attributes characterizing the offered technology. The characteristics may include, for example, latency, BW, jitter, probability of access, offered protocols, offered Quality of Service (QoS), offered protection types and offered Security levels. The GSO may also include one or more offered application objects, such as object 35. The offered application objects may identify certain characteristics of the application, such as the protocols supported by the application, etc. It should be noted that although certain technology and application attributes are mentioned, the list is not meant as exhaustive, but merely as representative. It is understood that various missions may require services and applications to be characterized in particular manners too numerous to mention. Thus the present invention is not limited to the inclusion of any specific type of attribute information in the GSO data structure.

Referring back to FIG. 1, the DES 13 examines the GSO data structures to identify INS entities having the capability of supporting the mission services. Once the DES has identified the INS entities that may be capable of supporting the mission, the DES issues a tender to the identified INS entities. It should be noted that not all INS entities will have mission support capability. For example, tenders for missions requiring wireless transmission should not be forwarded to INS entities that do not include wireless capability. INS entities that do not include mission support capability are said to be inappropriate INS entities for the mission. In one embodiment tenders are not forwarded to inappropriate INS entities in order to minimize unnecessary bandwidth utilization.

FIG. 1 shows that the directory maintains a copy of the GSO data structure 17a for each INS entity. The GSO data structure may be populated and maintained in a variety of manners. In one embodiment, each INS entity is responsible for maintaining its associated GSO data base. In an alternatively embodiment, the INS is populated via queries issued by the MRM to the INS entity. In either case, it is advantageous to periodically update the GSO data structure so that it reflects the current operating capabilities of the INS to decrease the forwarding of inappropriate tenders to the INS entities.

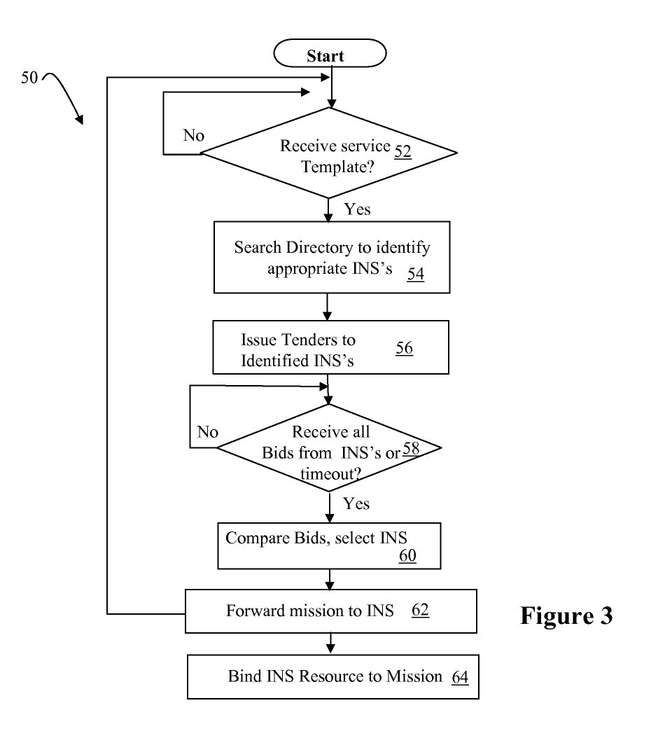

FIG. 3 is a flow diagram that illustrates several exemplary steps that may be performed by a DES 13 when issuing tenders in the present invention. When the DES receives a service template at step 52, it searches directory 16 to identify appropriate INS entities for issuance of tenders. At step 56, once the appropriate INS entities have been identified, the DES issues the tenders to the identified appropriate INS entities, and at step 58 begins to receive bids. The process may wait until all bids are received, or may have a time out period, during which bids must be received to be considered as viable INS entities by the DES.

At step 60, when all bids have been received, the bids forwarded by each INS entity are forwarded to the constraint analyzer CA 15 for comparison. The CA analyzes the bids to identify the INS entity that is best suited to support the mission. The particular method that is used to select among INS entities is obtained by a multi-dimensional analysis likely by an Expert Engine which takes into account the available of resources, the cost of the services, indicated by the INS, as well as constraints on the mission and relative priorities of the mission services. In Step 64, a final binding of resources to mission occurs. In one embodiment, the priorities of the mission services are temporally dynamic and defined using time-value curves, as described in patent application Ser. No. ______ (attorney docket number 120-504) entitled “Time-Value Curves to Provide Dynamic QoS for Time Sensitive File Transfers” by Schofield et. al. incorporated herein by reference.

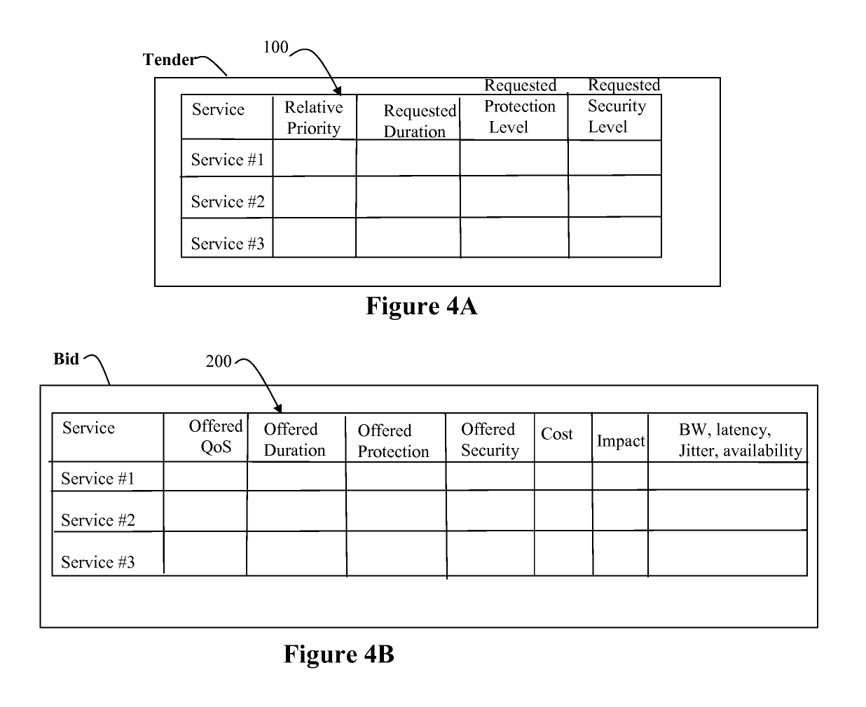

FIGS. 4A and 4B illustrate exemplary data structures that may be used to define a tender and bid which may be used in the present invention. The tender of FIG. 4A is shown to include, for example, a list of services that are included in the mission. The tender may include a request to bid on one or more (or all) of the services identified in the service set. Each service may have one or more service related bid elements, including temporal bid elements (such as an initiation, termination or duration) priority bid elements (such as QoS, service, and/or bandwidth), security bid information, protection bid information, etc. The present invention is not limited to the inclusion of any particular service related bid elements.

FIG. 4B illustrates exemplary bid data structure 200. The bid data structure includes offers for one or more of the service related bid attributes. This is meant as an example, whereas a input into an Expert Engine would be more complex and comprehensive. The offer indicates whether or to what extent the INS entity is able to support the service request. The bid data structure may also include additional bid related fields, such as a financial cost of the service or an impact in performance cost caused by the service (i.e., to what extent other services may be affected) The bid data may identify other services that may suffer in performance if the bid is accepted. Any other information of interest to the mission resource manager when selecting an INS may also be included within the scope of the present invention.

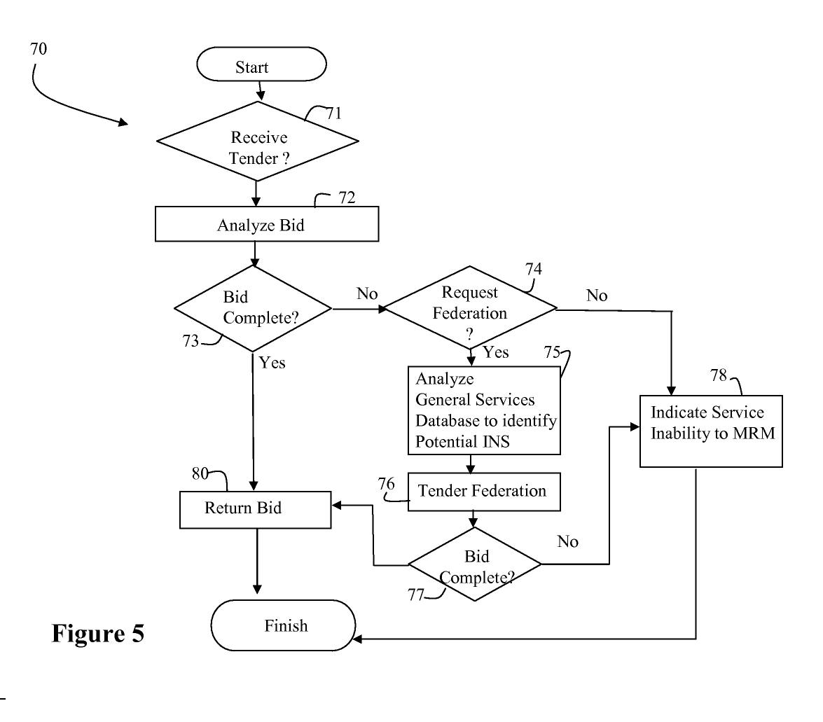

FIG. 5 is a flow diagram which illustrates several steps that may be performed by an INS entity supporting the present invention. After the Network Service Manager 26 receives a tender at step 71, at step 72 it analyzes each of the services in the tender, reviewing the request in view of current network resource utilization. Information regarding network utilization may be stored in the resource monitor and topology discovery database 27 (FIG. 1). The INS entity determines at step 73 the extent to which it can service the bid. If the INS determines that it can service the bid, then at step 80 it populates the bid data structure with offered bids for one or more of the services and returns the bid to the MRM.

If, however, it is determined at step 73 that the INS cannot service one or more aspects of the tender, at step 74 it is determined whether it can attempt to federate with another INS. Some embodiments may limit or prohibit federation between INS for security purposes . . . If it is determined that the INS cannot attempt to federate with another INS, then at step 78 the INS indicates an inability to provide service to the MRM. The indication may be in the form of an explicit response or alternatively may be inferred by a failure to response to the tender within a predetermined time frame.

However, if it is determined that the INS can request federation in order to fill the gaps of the resource offering, then at step 75 the INS identifies other INS that may assist in the provision of services to the mission. The INS may identify the INS in many ways, for example by maintaining a local copy of at least a subset of the GSO data structure stored in the directory 16.

At step 76, the INS tenders a bid to attempt federation. In one embodiment, a separate communication channel is advantageously maintained between INS entities to allow for federation of INS entities in the delivery of mission services to the MRM. In FIG. 1, for example, the communication channel includes tender federation busses 111, which may be used to exchange the tenders, and execution federation busses 113 which may be used to control the execution of federated services by the Execution Engine. Although the channels 111 and 113 are shown as physical busses, it should be understood that they may be implemented in any manner, virtual or physical.

If the INS is unable to receive an acceptable bid for federation, then the process proceeds to step 78 to indicate the inability to the MRM, as described above.

If, however, the bid is acceptable, the INS includes any cost and performance information provided by the federated INS into its bid, and returns the bid to the source of the tender at step 80.

Accordingly, a method and architecture has been shown and described that allows a centralized mission manager to understand the details of the network at a service level, thereby enabling service resource management to be optimized. As a result, mission goals can be successfully completed using mission optimal resources which take into account the dynamic nature of the networked environment.

Having described various embodiments of the invention, it will be appreciated that many of the above figures are flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem

The above description and figures have included various process steps and components that are illustrative of operations that are performed by the present invention. These components may be implemented in hardware, software or a combination thereof. However, although certain components and steps have been described, it is understood that the descriptions are representative only, other functional delineations or additional steps and components can be added by one of skill in the art, and thus the present invention should not be limited to the specific embodiments disclosed. In addition it is understood that the various representational elements may be implemented in hardware, software running on a computer, or a combination thereof.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A method of managing the allocation of resources to a mission includes the steps of:
identifying a service associated with a mission, the service having service related bid elements; and
issuing a tender to a plurality of coupled network entities, the tender for requesting bids for at least one of the service related bid elements.

2. The method of claim 1, further including the steps of:
receiving a set of bids from the plurality of coupled network entities; selecting one of the plurality of network entities to provide the service in response to the set of bids; and
forwarding the service to the selected one of the plurality of network entities.

3. The method of claim 1 wherein the service related bid elements includes temporal characteristics.

4. The method of claim 1, wherein the service related bid elements includes cost characteristics.

5. The method of claim 1 wherein the service related bid elements includes priority characteristics.

6. The method of claim 1 wherein the service related bid elements includes protection characteristics.

7. A method of allocating network resources includes the steps of:
receiving a tender request from a manager, the tender identifying a service and a service related bid elements; and
in response to the tender request, issuing a bid on the service related bid element, the bid quantifying an ability to provide the service.

8. The method of claim 7, further including the step of:
forwarding the tender to a peer entity to federate with the peer entity to provide the service to the manager.

9. An apparatus comprising a computer readable medium having program code stored thereon, the program code for controlling the allocation of network services to a mission, the apparatus comprising:
a directory, stored on the computer readable medium, and including, for each one of a plurality of networks available to the apparatus, a general service offering data structure, the general service offering data structure identifying a plurality of capabilities of the associated network; and
means for generating tender requests to the plurality of networks to request current service related bid information for each of the associated networks.

10. A controller comprising:
a directory for storing, for each one of a plurality of coupled network entities, information associated with the services provided by the respective network;
means, in response to the receipt of a service request for issuing a request to each of the coupled network entities to determine the capacity of the associated network to accommodate the service; and
forwarding a workflow associated with the service request to a selected network entity, the selected network entity being selected in response to a determined capacity of the selected network to accommodate the service.

11. The controller of claim 10, wherein the information associated with the service provided by the respective network includes temporal information.

11. The controller of claim 10, wherein the information associated with the service provided by the respective network includes priority information.

12. The controller of claim 10, wherein the information associated with the service provided by the respective network includes service dependency information.

13. The controller of claim 10, wherein the information associated with the service provided by the respective network includes security information.

14. The controller of claim 10, wherein the selected network entity is further selected in response to a relative determined capability of selected entity in comparison with the determined capability of the coupled network entities.
